(19) United States
(12) Patent Application Publication
(10) Pub. No.: US 2008/0220834 A1
(43) Pub. Date: Sep. 11, 2008

(54) Protective Shroud

(75) Inventor: Robert Nicholas Sofoulis, Leeming (AU)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Sentinal Gardens Pty Ltd., Leeming (AU)

(21) Appl. No.: 10/575,841

(22) PCT Filed: Oct. 14, 2004
(86) PCT No.: PCT/AU04/01409

§ 371 Date: May 29, 2008

(30) Foreign Application Priority Data
Oct. 14, 2003 (AU) 2003905591

(51) Int. Cl. H04M 1/02

(52) U.S. Cl. 455/575.8

(57) ABSTRACT

A shroud (11) for protecting a communication device, the shroud (11) comprises a receptacle (15) having an opening (21) to receive the device. The receptacle (15) is adapted to releasably retain the device therein. The shroud (11) is movable between a closed condition and an open condition, wherein in the open condition the communication device is fully operable, while in the closed condition the communication device is substantially protected from damage.

### FIELD OF THE INVENTION

The present invention generally relates to a protective shroud. In particular the protective shroud is used to provide protection for communication devices.

### BACKGROUND ART

It is common practice to place mobile communication devices in a cover to provide protection to the device. The majority of these covers are made from a flexible material, such as leather, and have apertures, and/or clear plastic which cover areas of the device required for operation. Typically these covers can be secured to a belt or the like for ease of carrying.

In some applications, a communication network is required which is independent of any other system. Such networks are required on construction sites and mine sites where two-way radio is used between various locations on site. In these applications mobile communication devices must be capable of sending their own signal a substantial distance. In these applications the operation conditions are less than perfect requiring the communication device to have a more robust design in order to reduce its vulnerability to failure due to dust, dirt, chemical or similar contamination. As a result most communication devices used on mine sites and constructions sites are bulkier, heavier and more expensive.

To date, the covers used to protect such devices either add significantly to the size and weight of the device and/or are not able to withstand the conditions found on site. These covers may also hinder the operation of the device.

Leather covers, similar to those used on mobile phones are available for two-way radios. These covers quickly deteriorate beyond useful protection due to the harsh conditions the communication device is used. Furthermore, these covers do not provide any protection to the communication device if dropped.

There is a further cover available for these type of devices. This cover is more robust being made from a thicker, less flexible leather, and incorporate a bulky coupling which secures the cover to a corresponding coupling member fitted to the belt of a user. However, as a result of the increase in size, the communication device, when worn, often knocks against structures and can be dislodged from the belt, particularly in confined areas. This can be particularly dangerous on sites having elevated platforms. As a result of the bulkiness operators often opt not to use the cover but rather carry the communications device in their hand.

The preceding discussion to the invention is intended only to facilitate an understanding of the present invention. It should be appreciated that the discussion is not an acknowledgement or an admission that any of the material referred to was or is part of the common general knowledge in Australia as at the priority date of the application.

It is an object of the present invention to ameliorate, mitigate or overcome, at least one disadvantage of the prior art, or which will at least provide the public with a practical choice.

### DISCLOSURE OF THE INVENTION

The present invention provides a shroud for protecting a communication device, the shroud comprises a receptacle having an opening to receive the device, the receptacle being adapted to releasably retain the device therein, the shroud is movable between a closed condition and an open condition, wherein in the open condition the communication device is fully operable, while in the closed condition the communication device is substantially protected from damage.

Preferably the shroud comprises a first member. Preferably when the shroud is in the closed condition the first member substantially covers and protects a functional face of the device when the device is received in the receptacle.

The first member may be hingedly connected to the receptacle at a first end. The first member may be removable from the receptacle when in a predetermined position relative to the receptacle.

The first member may be releasably locked to the receptacle when the shroud is in the closed condition.

Preferably the first member comprises a latch. The latch may be located adjacent a second end of the first member. Preferably the latch cooperates with the receptacle to releasably secure the first member to the receptacle when the shroud is in the closed condition. In one form of the invention the latch cooperates with an edge of the opening of the receptacle.

The shroud may have a first retaining means. Preferably the receptacle incorporates the first retaining means. The retaining means may be incorporated in a rear wall of the receptacle. The first retaining means may comprise at least one resiliently flexible locking tab adapted to releasably engage a corresponding locking portion on the communication device to releasably retain the device within the receptacle.

When in the open condition, the communication device may be removed from the shroud by urging the communication device towards the opening until it causes the first retaining means to disengage from the device.

In one form of the invention the shroud has a second retaining means. The second retaining means may comprise a locking projection extending from the first member, such that when in the closed condition the locking projection extends at least partially across the opening of the receptacle. When the communication device is received in the receptacle and the shroud is in the closed condition the locking projection prevents the communication device from passing through the opening.

The locking projection may extend inwardly from the second end of the first member.

Preferably when the communication device is retained in the shroud functional components located on top of the device are accessible through the receptacles opening.

The first member may incorporate a tab which may be used to release the second end of the first member from the receptacle.

In one form of the invention the tab of the first member is configured to also provide protection to functional components on the communication device.

The tab may be integral with the locking projection of the second retaining means. The tab may extend substantially perpendicular to the locking projection at a remote end thereof.

Preferably when the communication device is received in the shroud, a portion of the receptacle projects sufficiently to protect the functional components on the communication device. Preferably the portion is incorporated in the rear wall of the receptacle.

Preferably the receptacle incorporates a plurality of apertures to allow an operator to use the communication device when retained therein.

Preferably each aperture located on a front wall of the receptacle has a raised profile around its periphery. The raised profile, adds a further degree of protection to the communication device.

The shroud may be adapted to be secured to the user. This may be achieved by having a clipping means incorporated with the shroud or providing means on the shroud capable of having a clipping means fitted thereto.

In one aspect of the invention the clipping means allows the shroud to be clipped onto a belt. Preferably the clipping means is secured to the rear wall of the receptacle. The clipping means may co-operate with a rebate or opening in the receptacle which is positioned to receive an end of the clipping means so as to assist with securement of the shroud to the belt. The clipping means may be the type commonly used on current covers.

In a second aspect of the invention, securement of the shroud to the user is achieved using a lanyard/strap. The lanyard/strap may have both ends connected to the shroud to form a loop. The ends may have clips which clip through attachment holes in the receptacle.

The shroud may be made substantially from plastic. Preferably the plastic can be coloured.

Preferably the shroud is made from a shock absorbing polymer.

Preferably the shroud is made from a chemical resistant material.

The shroud may be made from a blend of polymers such as a blend of polycarbonate and acrylonitrile-butadiene-styrene co-polymers.

Preferably the first member is resiliently flexible.

The first member may be capable of bearing indicia.

The receptacle may be capable of bearing indicia.

The shroud may be engraved.

The shroud may be manufactured to particularly suit Motorola® brand communication devices of any size.

The shroud may allow communication when the shroud is in the closed condition. The shroud may be configured such that when in the closed condition, the sound emanating from the communication device is directed towards the operator.

The present invention further provides a shroud for protecting a communication device, the shroud comprises a receptacle having an opening to receive the device, the shroud further comprises a first member which is movable with respect to the receptacle to move the shroud between a closed condition and an open condition, wherein in the open condition the communication device is fully operable, while in the closed condition the communication device is substantially protected from damage, the receptacle incorporates a first retaining means in a rear wall thereof, the first retaining means comprising at least one resiliently flexible locking tab adapted to releasably engage a corresponding locking portion on the communication device to releasably retain the device within the receptacle.

The present invention further provides a shroud for protecting a communication device, the shroud comprises a receptacle having an opening to receive the device, the receptacle being adapted to releasably retain the device therein, the shroud further comprises a first member which is movable with respect to the receptacle to move the shroud between a closed condition and an open condition, wherein in the open condition the communication device is fully operable, while in the closed condition the communication device is substantially protected from damage, the shroud also incorporates a retaining means comprising a locking projection extending from the first member, such that when in the closed condition the locking projection extends at least partially across the opening of the receptacle preventing the communication device from passing through the opening when the shroud is in the closed condition.

The shroud of the present invention is a light cover which adds minimal size to current communication devices and does not hinder the operation of the device. The shroud provides a barrier between the environment and the device as well as having shock absorbing capabilities should the device be dropped.

The design of the shroud allows the operator to communicate when the shroud is in the closed condition, concentrates and directs the sound towards the operator such that the device can be used in noisy locations. The shroud is designed to protect both the device and the functional components of the device reducing the amount of maintenance or replacement which may otherwise be required.

### BRIEF DESCRIPTION OF THE DRAWINGS

The invention will be better understood by reference to the following description of a specific embodiment thereof as shown in the accompanying drawings in which:

FIG. 1 is a perspective view of a protective shroud in an open condition according to an embodiment of the invention;

FIG. 2 is a perspective view of the protective shroud in a closed condition;

FIG. 3 is a perspective view of a receptacle;

FIG. 4 is a sectional view of “C” of FIG. 3;

FIG. 5 is a sectional view of “A” of FIG. 3;

FIG. 6 is a perspective view of a first member;

FIG. 7 is a sectional view of “B” of FIG. 6;

FIG. 8 is a front view of FIG. 1;

FIG. 9 is a right side view of FIG. 1;

FIG. 10 is a right side view of FIG. 2;

FIG. 11 is a left side view of FIG. 2;

FIG. 12 is a plan view of FIG. 2;

FIG. 13 is a front view of FIG. 2;

FIG. 14 is a rear view of FIG. 2; and

FIG. 15 is a bottom view of FIG. 2.

### BEST MODE(S) FOR CARRYING OUT THE INVENTION

Referring to the figures, the invention according to an embodiment is in the form of a protective shroud 11 for a communication device (not shown). The shroud 11 comprises a receptacle 15 and a first member 17 hingedly connected to the receptacle 15 at a first end 19.

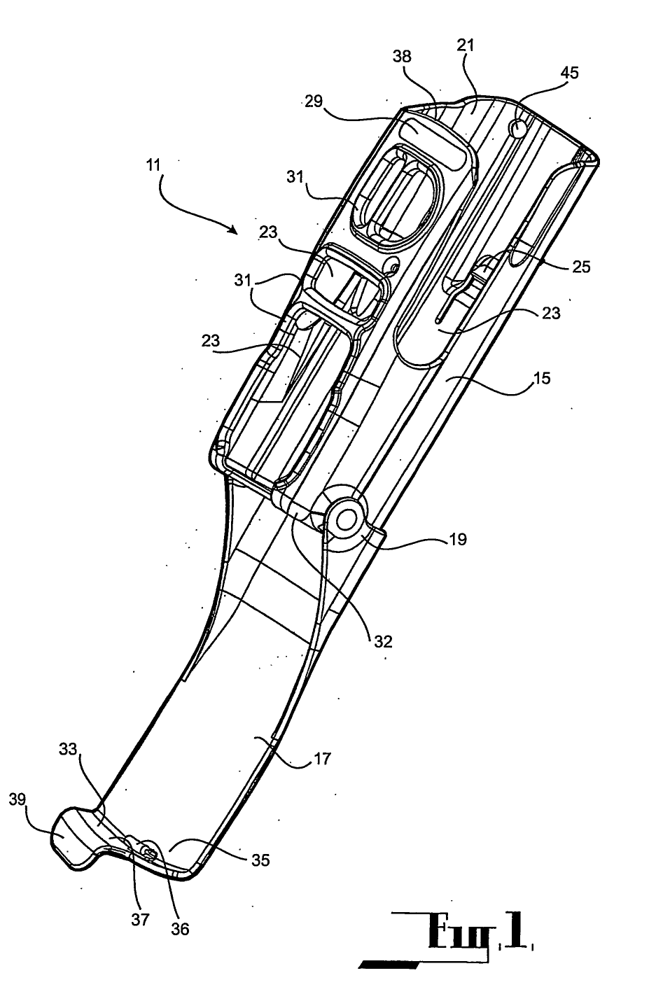

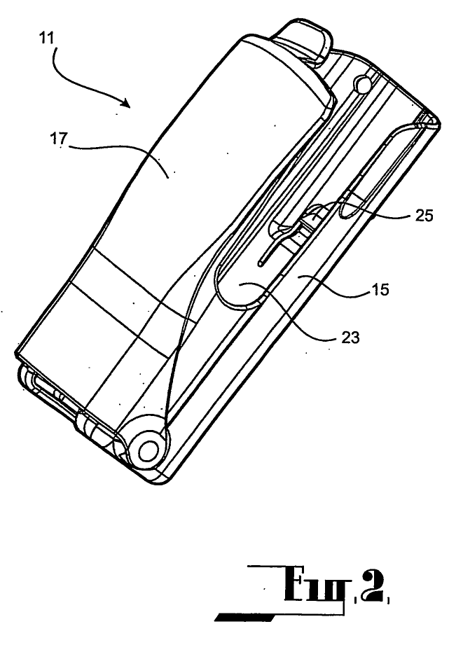

The shroud 11 is capable of moving between an open condition, as shown in FIG. 1, to a closed condition, as shown in FIG. 2.

The receptacle 15 incorporates an opening 21 for receiving the communication device. The receptacle 15 also incorporates a plurality of apertures 23 which allow for the operation of the communication device when the shroud 11 is in the open condition.

The apertures 23a on a front wall 29 of the receptacle 15 have a raised profile 31 around their periphery. The raised profile 31 provides a degree of protection to operational components of the communication device.

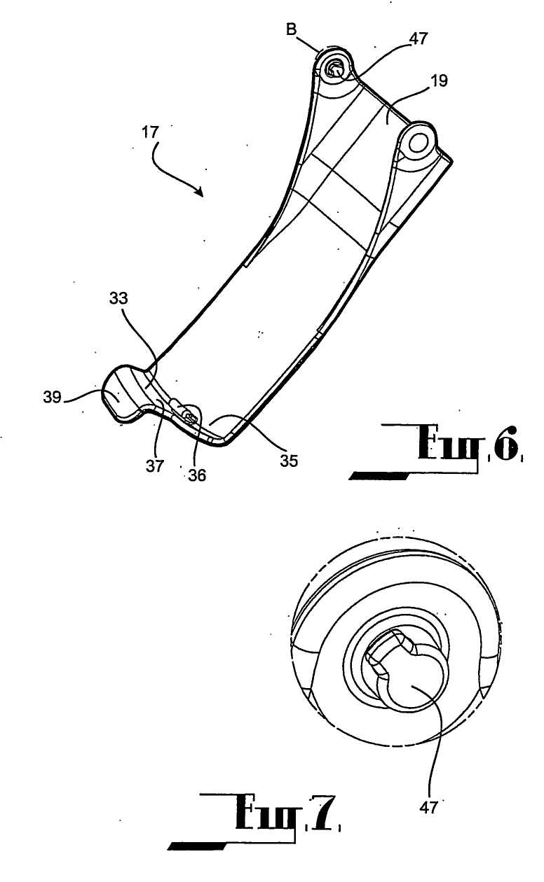

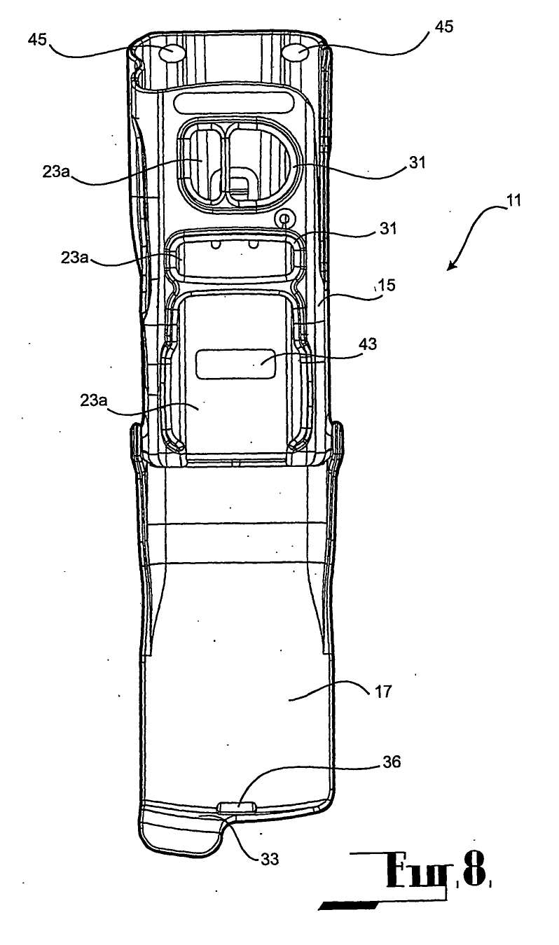

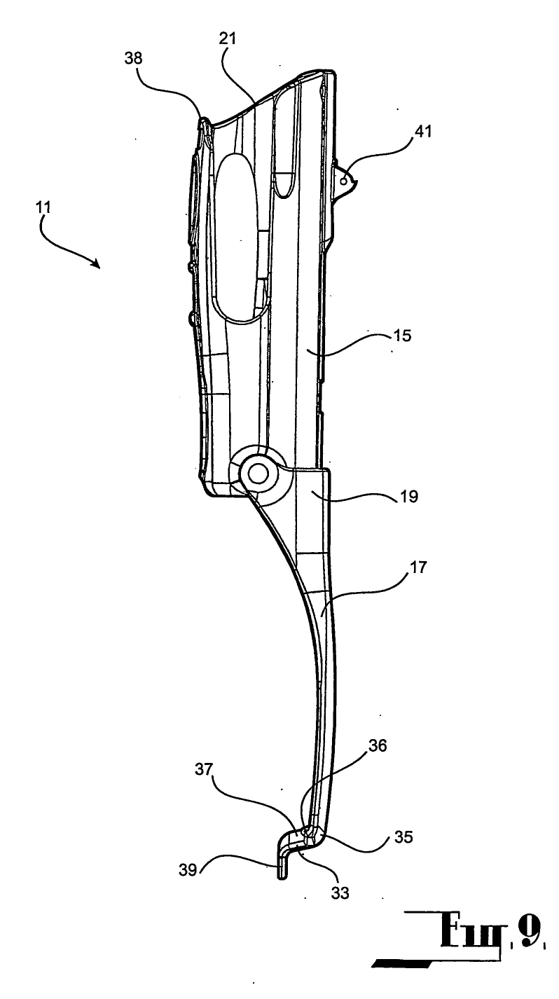

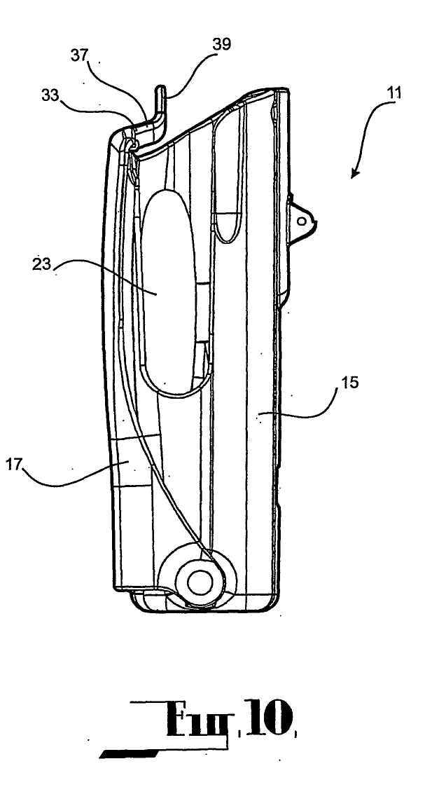

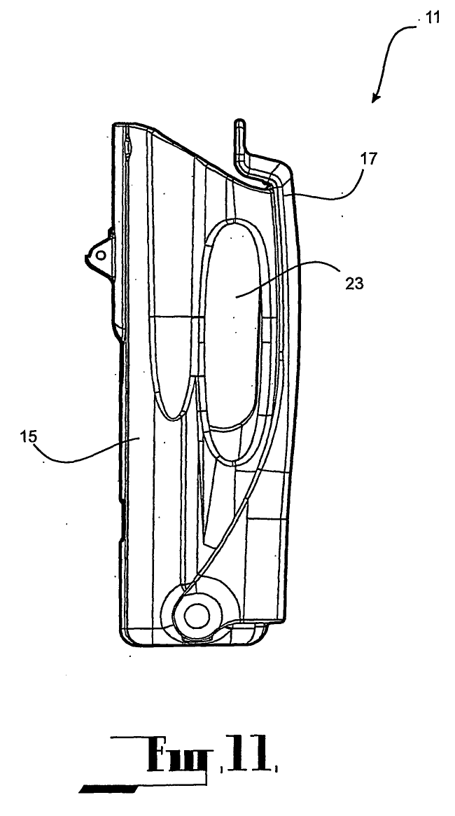

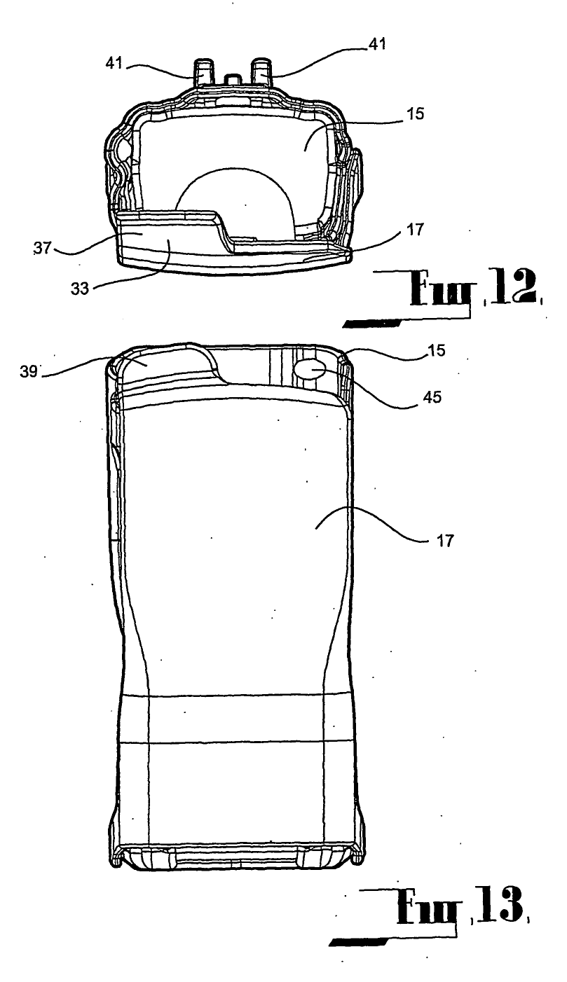

As best shown in FIGS. 3, 5, 6 and 7 the first member 17 is hingedly connected to the first end 19 of the receptacle 15 as previously discussed. At a second end 35 of the first member 17, two spigots 47 extend inwardly. The spigots 47 are configured to be releasably secured in housings 49 located at the bottom end 32 of the receptacle 15 so as to be rotatable between the open and closed conditions.

The first member 17 comprises a latch 36 in close proximity to the first end 19. The latch 36 cooperates with edge 38 of the opening 21 to releasably secure the first member 17 to the receptacle 15 when the shroud 11 is in the closed condition.

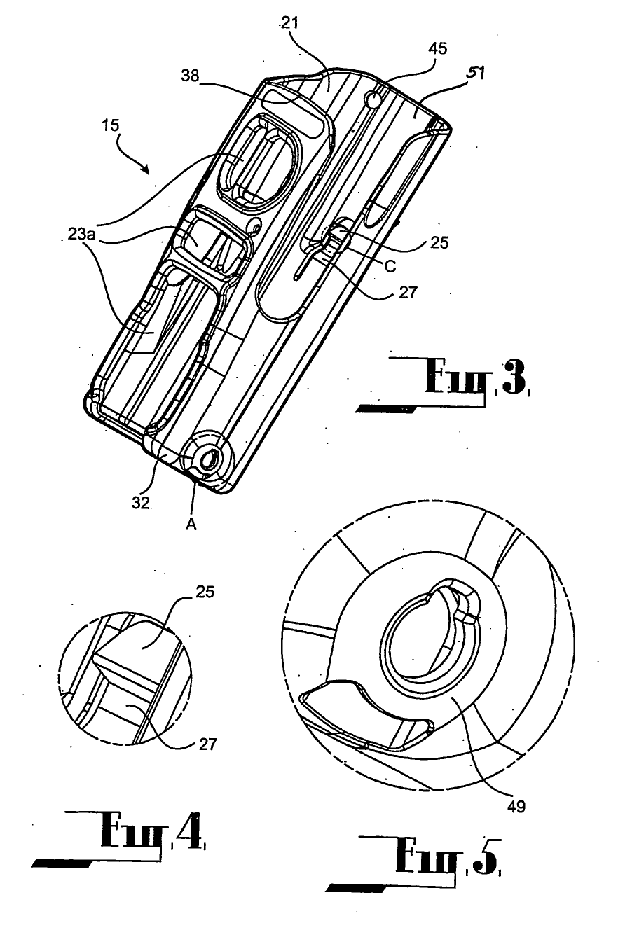

The receptacle 15 further incorporates a first retaining means 25, as best shown in FIGS. 3, 4 and 14, on a rear wall 26 of the receptacle 15. The first retaining means 25 comprises a resiliently flexible locking tab 27 which is adapted to releasably engage a corresponding portion on the communication device to releasably retain the device therein. As the communication device is being received in the receptacle 15, the flexible locking tab 27 is forced outwardly by the device until the corresponding portion on the communication device aligns therewith allowing the flexible locking tab 27 to return to its normal condition, moving inwardly and engaging the corresponding portion on the device.

In removing the communication device from the receptacle 15, the flexible locking tab 27 is designed such that upon application of sufficient force to the device the flexible locking tab 27 is caused to once again move outwardly and disengage the corresponding portion on the communication device, allowing the device to be removed. Once the communication device is removed, the flexible locking tab 27 returns to its normal position.

The first member 17 provides a second retaining means 33 at a second end 35 to also releasably retain the device within the receptacle 15. The second retaining means 33 comprises a locking projection 37 extending perpendicular and inwardly from the first member 17, such that when in the closed condition, the locking projection 37 extends partially across the opening 21 of the receptacle 15. When the shroud 11, accommodating a communication device, is in the closed condition, the locking projection 37 prevents the device from being removed from the receptacle.

The first member 17 also comprises a tab 39 which assists the operator in moving the shroud 11 from the closed to open condition. The tab 39 is integral with the locking projection 37, extending perpendicular therefrom at an end of the locking projection 37 remote from the first member 17.

The tab 39 extends sufficiently to provide protection to operational components located on top of the communication device when received in the receptacle 15.

The rear wall 26 of the receptacle 15 incorporates a portion 51 which extends upwardly a sufficient length such that when the communication device is received in the receptacle 15, the rear wall 26 also provides protection to operational components located on top of the communication device.

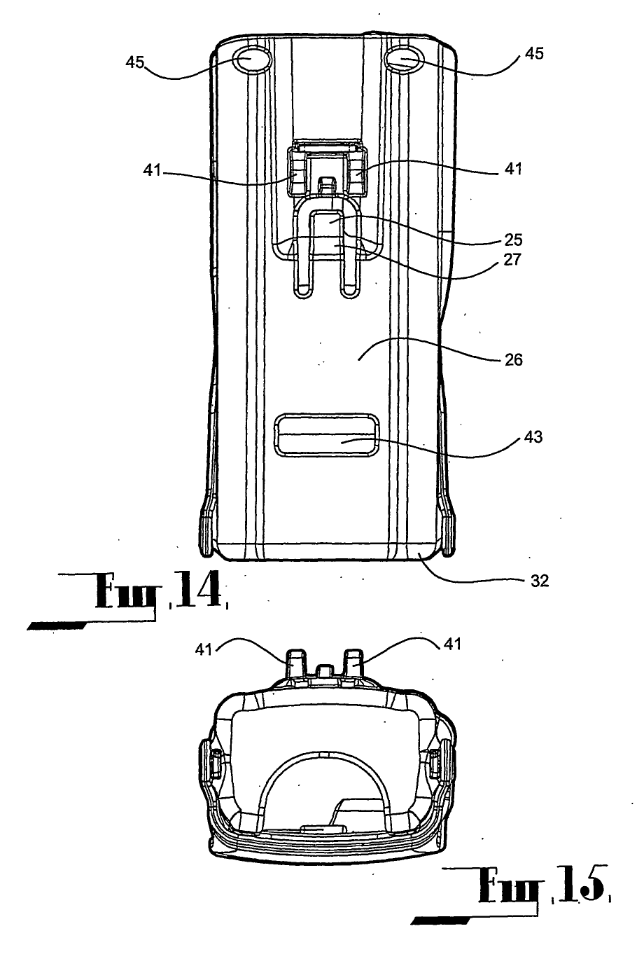

The shroud 11 has clipping means (not shown) for securing the shroud 11 to a belt or similar (not shown). The clipping means is connected to a pair of lugs 41 as shown in FIGS. 14 and 15. To assist the securement of the shroud 11 to a belt, the clipping means cooperates with an opening 43 located on the rear wall 26 of the receptacle 15.

The shroud 11 also has an alternative means of securing the shroud 11 to the operator. A strap/lanyard (not shown) can be attached, using clips, to attachment holes 45 to form a loop. The shroud 11 may then be placed around the operators neck and/or shoulder.

Whilst the above embodiment relates to a shroud for a specific device, the shroud can be adapted to receive and protect a variety of brands and sizes of communication devices. Such shrouds are considered to fall within the scope of this invention.

Modifications and variations such as that would be apparent skilled addressee are considered to fall within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

The claims defining the invention are as follows:

1. A shroud for protecting a communication device, the shroud comprises a receptacle having an opening to receive the device, the receptacle being adapted to releasably retain the device therein, the shroud is movable between a closed condition and an open condition, wherein in the open condition the communication device is fully operable, while in the closed condition the communication device is substantially protected from damage.

2. The shroud according to claim 1 comprising a first member.

3. The shroud according to claim 2 wherein when in the closed condition the first member substantially covers and protects a functional face of the device when the device is received in the receptacle.

4. The shroud according to claims 2 or 3 wherein the first member is hingedly connected to the receptacle at a first end.

5. The shroud according to claims 2, 3 or 4 wherein the first member is removable from the receptacle when in a predetermined position relative to the receptacle.

6. The shroud according to claims 2, 3, 4 or 5 wherein the first member is releasably locked to the receptacle when the shroud is in the closed condition.

7. The shroud according to any one of claims 2 to 6 wherein the first member comprises a latch.

8. The shroud according to claim 7 wherein the latch is located adjacent a second end of the first member.

9. The shroud according to claim 7 or 8 wherein the latch cooperates with the receptacle to releasably secure the first member to the receptacle when the shroud is in the closed condition.

10. The shroud according to claim 9 wherein the latch cooperates with an edge of the opening of the receptacle.

11. The shroud according any one of the preceding claims wherein the shroud has a first retaining means.

12. The shroud according to claim 11 wherein the receptacle incorporates the first retaining means.

13. The shroud according to claim 11 or 12 wherein the retaining means is incorporated in a rear wall of the receptacle.

14. The shroud according to claim 11, 12 or 13 wherein the first retaining means comprises at least one resiliently flexible locking tab adapted to releasably engage a corresponding locking portion on the communication device to releasably retain the device within the receptacle.

15. The shroud according to any one of the preceding claims wherein the shroud has a second retaining means.

16. The shroud according to claim 15 wherein the second retaining means comprises a locking projection extending from the first member, such that when in the closed condition the locking projection extends at least partially across the opening of the receptacle, preventing the communication device from passing through the opening.

17. The shroud according to claim 16 wherein the locking projection extends inwardly from the second end of the first member.

18. The shroud according to any one of the preceding claims wherein functional components of the communication device are accessible through the receptacles opening when the device is retained in the shroud.

19. The shroud according to any one claims 2 to 18 wherein the first member incorporates a tab which is used to release the second end of the first member from the receptacle.

20. The shroud according to claim 19 wherein the tab of the first member is configured to provide protection to functional components on the communication device.

21. The shroud according to claim 19 or 20 wherein the tab is integral with the locking projection of the second retaining means.

22. The shroud according to claim 19, 20 or 21 wherein the tab extends substantially perpendicular to the locking projection at a remote end thereof.

23. The shroud according to any one of the preceding claims wherein a portion of the receptacle projects sufficiently to protect the functional components on the communication device when received in the shroud.

24. The shroud according to claim 23 wherein the portion is incorporated in the rear wall of the receptacle.

25. The shroud according to any one of the preceding claims wherein the receptacle incorporates a plurality of apertures to allow an operator to use the communication device when retained therein.

26. The shroud according to claim 25 wherein each aperture located on a front wall of the receptacle has a raised profile around its periphery.

27. The shroud according to any one of the preceding claims wherein the shroud is adapted to be secured to the user.

28. The shroud according to claim 27 wherein the shroud is secured to the user using a clipping means, allowing the shroud to be clipped onto a belt.

29. The shroud according to claim 28 wherein the clipping means is secured to the rear wall of the receptacle, and co-operates with a rebate or opening in the receptacle which is positioned to receive an end of the clipping means so as to assist with securement of the shroud to the belt.

30. The shroud according to claim 27 wherein the shroud is secured to the user using a lanyard/strap having both ends connected to the shroud to form a loop.

31. The shroud according to any one of the preceding claims wherein the shroud is substantially made from plastic.

32. The shroud according to any one of the preceding claims wherein the shroud is substantially made from a shock absorbing polymer.

33. The shroud according to any one of the preceding claims wherein the shroud is substantially made from a chemical resistant material.

34. The shroud according to any one of the preceding claims wherein the shroud is substantially made from a blend of polymers such as a blend of polycarbonate and acrylonitrile-butadiene-styrene.

35. The shroud according to any one of claims 2 to 34 wherein the first member is resiliently flexible.

36. The shroud according to any one of the preceding claims wherein the shroud allows communication when the shroud is in the closed condition.

37. The shroud according to any one of the preceding claims wherein the shroud is configured such that when in the closed condition, the sound emanating from the communication device is directed towards the operator.

38. A shroud for protecting a communication device, the shroud comprises a receptacle having an opening to receive the device, the shroud further comprises a first member which is movable with respect to the receptacle to move the shroud between a closed condition and an open condition, wherein in the open condition the communication device is fully operable, while in the closed condition the communication device is substantially protected from damage, the receptacle incorporates a first retaining means in a rear wall thereof, the first retaining means comprising at least one resiliently flexible locking tab adapted to releasably engage a corresponding locking portion on the communication device to releasably retain the device within the receptacle.

39. A shroud for protecting a communication device, the shroud comprises a receptacle having an opening to receive the device, the receptacle being adapted to releasably retain the device therein, the shroud further comprises a first member which is movable with respect to the receptacle to move the shroud between a closed condition and an open condition, wherein in the open condition the communication device is fully operable, while in the closed condition the communication device is substantially protected from damage, the shroud also incorporates a retaining means comprising a locking projection extending from the first member, such that when in the closed condition the locking projection extends at least partially across the opening of the receptacle preventing the communication device from passing through the opening when the shroud is in the closed condition.

40. A shroud as substantially herein described with reference to the drawings.
